(19) United States
(12) Patent Application Publication
(10) Pub. No.: US 2016/0063445 A1
(43) Pub. Date: Mar. 3, 2016

(54) Method and System for Optimizing Retirement and Healthcare Benefits

(71) Applicant: FMR LLC, Boston, MA (US)

(72) Inventors: Steven Andrew Feinschreiber, Attelboro, MA (US); Stephen J. Devaney, Cohasset, MA (US); Christi Rager Wise, Wilmette, IL (US); Don Chun, Bedford, NH (US); Adheesh Sharma, Newton, MA (US)

(21) Appl. No.: 14/937,440

(22) Filed: Nov. 10, 2015

Related U.S. Application Data
(63) Continuation-in-part of application No. 13/454,659, filed on Apr. 24, 2012, now abandoned.

(51) Int. Cl. G06Q 10/10; G06Q 40/06; G06Q 40/08

(52) U.S. Cl. CPC G06Q 10/1057; G06Q 40/08; G06Q 40/06

(57) ABSTRACT

A method is provided for optimizing healthcare and retirement benefits for an employee. The method includes receiving information about at least one medical insurance plan and at least one retirement savings account for which the employee is eligible and selecting for the employee a medical insurance plan from the at least one medical insurance plan. The method also includes determining a first amount for the employee to contribute on a pre-tax basis to at least one health care savings account. The first amount is at least equal to an estimated total of eligible expenses not covered by the medical insurance plan. The method further includes determining a second amount for the employee to contribute to the at least one retirement savings account. Selection of the medical insurance plan, the first amount and the second amount optimize the healthcare and retirement benefits for the employee.

### RELATED APPLICATIONS

This application is a continuation-in-part of U.S. patent application Ser. No. 13/454,659, which was filed on Apr. 24, 2012, the entirety of which is incorporated herein by reference.

### TECHNICAL FIELD

The subject matter of the application relates generally to computer-implemented methods and apparatuses, including computer program products, for optimizing benefits, and more particularly, to optimizing healthcare and retirement benefits.

### BACKGROUND

Managing healthcare costs, already a concern for many families, is likely to become a major focus for families in the future. Over the past 10 years, the U.S. healthcare system has experienced a rate of inflation about 2.6 times higher than the rate of general economic inflation and this rate of increase is not expected to abate in the coming decade. Some of the factors contributing to rising healthcare expenses for families include, for example, rapid adoption by employers of high-deductible health plans (HDHPs), greater cost-sharing between employers and workers with more costs borne by the workers, higher deductibles and co-payments, shift from co-pays to co-insurance, employers dropping coverage, reduced or eliminated retiree health benefits and high unemployment.

A HDHP is a health insurance plan with lower premiums and higher deductibles than a traditional health plan. Individuals covered by a HDHP are generally eligible for a healthcare savings account, such as a health savings account (HSA) and/or a limited flexible spending account (limited FSA). A HSA is a tax-advantaged medical savings account available to taxpayers who are enrolled in a HDHP. The funds contributed to the HSA are not included in earned income, thus reducing income taxes. The funds in the HSA roll over and accumulate year to year if not spent. A FSA is a tax-advantaged financial account that can be created through an employer. The account allows an employee to set aside a portion of earnings to pay for qualified expenses in the current tax year only. Money deducted from an employee's pay into a FSA is also not subject to payroll taxes. Unlike the HSA, funds not used by the end of the plan year in a FSA are generally lost to the employee. Generally, for employees not enrolled in a HDHP, the employees can use a FSA to pay for qualified medical expenses. For employees enrolled in a HDHP, the employees can use a limited FSA to pay for qualified medical expenses, which may be limited to expenses related only to uncovered vision and/or uncovered dental, for example.

In view of rising healthcare costs, one of the greatest concerns for many families is that the increase in family healthcare expenses will overtake retirement savings, especially when wage growth is limited. For example, families may only be able to pay for today's healthcare by giving up tomorrow's retirement security.

### SUMMARY

Methods and apparatus are provided to implement practical strategies for managing healthcare costs. To help counteract the dramatic rise in healthcare costs during both a taxpayer's wealth accumulation and retiree years, the federal government has created tax-favored savings and investing opportunities. Methods and apparatus are provided to help taxpayers to optimize the allocation of their funds to various retirement and healthcare programs to increase their accumulated savings at retirement.

In one aspect, a computerized method is provided for optimizing healthcare and retirement benefits for an employee. The method includes receiving, by a computing device from a graphical user interface device, input identifying a participant and a contribution budget for the participant that specifies a total amount available for allocation for a remaining part of the current year. The computing device determine one or more medical insurance plans for which the participant is eligible and selects a medical insurance plan from the one or more medical insurance plans for which the employee is eligible based upon the contribution budget. The computing device determines at least one health care savings account associated with the at least one medical insurance plan and retrieves information identifying a plurality of financial accounts associated with the participant, where the plurality of financial accounts comprises at least a retirement account associated with a retirement plan, a qualified plan, and at least one health care account associated with a health care plan, where the retrieved information comprises at least an annual limit on participant contribution amounts for each of the financial accounts and previous contribution amounts deposited respectively in each of the financial accounts during the current year by the participant. The computing device generates a savings hierarchy that identifies a plurality of savings milestones for the remaining part of the current year represented by data comprising (i) a recommended funding sequence of the plurality of financial accounts, the qualified plan, and the health care account and (ii) recommended contribution amounts for the plurality of financial accounts, the qualified plan and the health care account at each step of the funding sequence for the remaining part of the current year, wherein the recommended funding sequence and the recommended contribution amounts are dependent on the partial year adjusted contribution limits, including (a) providing recommendation of a first amount for the employee to contribute on a pre-tax basis to the at least one health care savings account, wherein the first amount is equal to smaller of (i) an estimated total of eligible expenses not covered by the medical insurance plan and (ii) a contribution limit of the health care savings account, the estimated total eligible expenses representing an after-tax amount the employee spends on healthcare reduced by at least one of employer contribution to the health care savings account or existing balance in the health care savings account; (b) providing recommendation of a second amount for the employee to contribute to the qualified plan, wherein the second amount is equal to a matching contribution limit of the qualified plan; (c) providing, by the computing device, recommendation of a third amount for the employee to contribute on a pre-tax basis to the at least one health care savings account, where the third amount is equal to smaller of (i) a remaining eligible expense after the first amount is subtracted from the eligible expenses and (ii) the contribution limit of the at least one health care savings account subtracted by the first amount; (d) providing recommendation of a fourth amount for the employee to contribute to the qualified plan, where the fourth amount is equal to the contribution limit of the qualified plan subtracted by the second amount; and (e) providing, by the computing device, recommendation of a fifth amount for the employee to contribute to the at least one retirement account, wherein the fifth amount is equal to a contribution limit of the at least one retirement account. The computing device allocates the contribution budget across the financial accounts according to the recommended funding sequence and up to the recommended contribution amounts of the savings hierarchy limited by the contribution budget; and transmits the saving hierarchy including the recommended funding sequence and the recommended contribution amounts for display on the graphical user interface device, where the display includes an arc-shaped spectrum graphical representation that visually depicts (i) the savings hierarchy as a plurality of consecutive sectors, each sector identifying a step in the recommended funding sequence, a length of each sector representing a corresponding recommended contribution amount, and the respective positions of the plurality of consecutive sectors representing the recommended funding sequence and (ii) a graphical indicator referencing a position on the savings hierarchy that represents a level to which the financial accounts are funded by the allocated contribution budget.

In another aspect, a computer program product, tangibly embodied in a non-transitory computer readable storage medium, is provided for optimizing healthcare and retirement benefits for an employee. The computer program product includes instructions being operable to cause a computing device to receive, from a graphical user interface device, input identifying a participant and a contribution budget for the participant that specifies a total amount available for allocation for a remaining part of the current year, determine one or more medical insurance plans for which the participant is eligible, select a medical insurance plan from the one or more medical insurance plans for which the employee is eligible based upon the contribution budget, and determine at least one health care savings account associated with the at least one medical insurance plan. The computer program product includes instructions being operable to cause the computing device to retrieve information identifying a plurality of financial accounts associated with the participant, where the plurality of financial accounts comprises at least a retirement account associated with a retirement plan, a qualified plan, and at least one health care account associated with a health care plan, where the retrieved information comprises at least an annual limit on participant contribution amounts for each of the financial accounts and previous contribution amounts deposited respectively in each of the financial accounts during the current year by the participant. The computer program product includes instructions being operable to cause the computing device to generate a savings hierarchy that identifies a plurality of savings milestones for the remaining part of the current year represented by data comprising (i) a recommended funding sequence of the plurality of financial accounts, the qualified plan, and the health care account and (ii) recommended contribution amounts for the plurality of financial accounts, the qualified plan and the health care account at each step of the funding sequence for the remaining part of the current year, wherein the recommended funding sequence and the recommended contribution amounts are dependent on the partial year adjusted contribution limits, including providing, by the computing device, recommendation of a first amount for the employee to contribute on a pre-tax basis to the at least one health care savings account, wherein the first amount is equal to smaller of (i) an estimated total of eligible expenses not covered by the medical insurance plan and (ii) a contribution limit of the health care savings account, the estimated total eligible expenses representing an after-tax amount the employee spends on healthcare reduced by at least one of employer contribution to the health care savings account or existing balance in the health care savings account; providing, by the computing device, recommendation of a second amount for the employee to contribute to the qualified plan, wherein the second amount is equal to a matching contribution limit of the qualified plan; providing, by the computing device, recommendation of a third amount for the employee to contribute on a pre-tax basis to the at least one health care savings account, wherein the third amount is equal to smaller of (i) a remaining eligible expense after the first amount is subtracted from the eligible expenses and (ii) the contribution limit of the at least one health care savings account subtracted by the first amount; providing, by the computing device, recommendation of a fourth amount for the employee to contribute to the qualified plan, wherein the fourth amount is equal to the contribution limit of the qualified plan subtracted by the second amount; and providing, by the computing device, recommendation of a fifth amount for the employee to contribute to the at least one retirement account, wherein the fifth amount is equal to a contribution limit of the at least one retirement account. The computer program product includes instructions being operable to cause the computing device to allocate the contribution budget across the financial accounts according to the recommended funding sequence and up to the recommended contribution amounts of the savings hierarchy limited by the contribution budget; and transmit the saving hierarchy including the recommended funding sequence and the recommended contribution amounts for display on the graphical user interface device, where the display includes an arc-shaped spectrum graphical representation that visually depicts (i) the savings hierarchy as a plurality of consecutive sectors, each sector identifying a step in the recommended funding sequence, a length of each sector representing a corresponding recommended contribution amount, and the respective positions of the plurality of consecutive sectors representing the recommended funding sequence and (ii) a graphical indicator referencing a position on the savings hierarchy that represents a level to which the financial accounts are funded by the allocated contribution budget.

In other examples, any of the aspects above can include one or more of the following features. In some embodiments, the at least one health care savings account includes a flexible spending account or a health savings account.

In some embodiments, the at least one retirement savings account is a qualified plan and the second amount is less than or equal to a matching contribution limit of the qualified plan. The qualified plan can be a 401(k) plan, in which case the second amount is a pre-tax contribution and an expected marginal tax rate of the employee in retirement is less than or equal to a current marginal tax rate of the employee. The qualified plan can be a Roth 401(k) plan, in which case the second amount is an after-tax contribution, and an expected marginal tax rate of the employee in retirement is greater than or equal to a current marginal tax rate of the employee.

In some embodiments, a first pre-tax amount for the employee to contribute to a flexible spending account is determined. The first pre-tax amount has a fixed cap for eligible expenses not covered by the medical insurance plan. In addition, a second pre-tax amount for the employee to contribute to a health savings account is determined. The second pre-tax amount is for eligible expenses not covered by the medical insurance plan. Proceeds of the health savings account can be carried over to a subsequent plan year.

In some embodiments, a third amount is determined. The third amount is for the employee to contribute on a pre-tax basis to the at least one health care savings account. The third amount is less than or equal to a contribution limit of the at least one health care savings account. In addition, a fourth amount is determined. The fourth amount is for the employee to contribute to the at least one retirement savings account. The fourth amount is less than or equal to a contribution limit of the at least one retirement savings account. The fourth amount can be a pre-tax contribution, in which case the at least one retirement savings account can be a 401(k) plan and an expected marginal tax rate of the employee in retirement is less than or equal to a current marginal tax rate of the employee. The fourth amount can be an after-tax contribution, in which case the at least one retirement savings account can be a Roth 401(k) plan and an expected marginal tax rate of the employee in retirement is greater than or equal to a current marginal tax rate of the employee.

In some embodiments, determination is made for an amount for the employee to contribute on a pre-tax basis to at least one of a traditional IRA of the employee or a traditional IRA of a spouse of the employee. In addition, determination is made for an amount for the employee to contribute on an after-tax basis to a Roth IRA of the employee or a Roth IRA of a spouse of the employee. In some embodiments, the determination of the amount for the employee to contribute on a pre-tax basis is not executed when an expected marginal tax rate of the employee in retirement is greater than or equal to a current marginal tax rate of the employee. In some embodiments, the employee is prevented from withdrawing an eligible expense from the at least one health care savings account.

In some embodiment, determination is made for an amount for the employee to contribute on an after-tax basis to at least one of a traditional IRA of the employee or a traditional IRA of a spouse of the employee.

In some embodiments, determination is made for an amount for the employee to contribute on an after-tax basis to a tax-deferred annuity or a taxable account.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows a flow chart depicting a general process for managing retirement and healthcare benefits.

FIG. 2 shows an exemplary implementation of the general process of FIG. 1.

FIG. 3 shows another exemplary implementation of the general process of FIG. 1.

FIGS. 4A-D show case studies for utilizing the benefits allocation processes of FIGS. 1-3.

FIG. 5A is an exemplary graphical user interface page for receiving personal information.

FIG. 5B is an exemplary graphical user interface page for receiving health account and retirement plan contribution information.

FIG. 5C is an exemplary graphical user interface page for receiving partial year input information.

FIG. 5D is an exemplary graphical user interface page for representing an example savings hierarchy analysis and results including a milestones dial feature.

FIG. 5E is an exemplary graphical user interface page for representing an example estimated balances analysis including an illustrative growth feature.

FIG. 5F is an exemplary graphical user interface page for representing an example emergency fund analysis.

### DETAILED DESCRIPTION

Retirement and healthcare benefits are becoming intertwined due to the advent of HDHPs with HSAs and a continued shift to defined contribution (DC) retirement savings in which employers specify the amount of their contribution. To leverage this trend, a DC framework is offered for both retirement and healthcare savings. For example, if an individual has a HDHP option, the individual's retirement and healthcare benefits can be simultaneously optimized by taking into account of the individual's retirement income needs and healthcare situation.

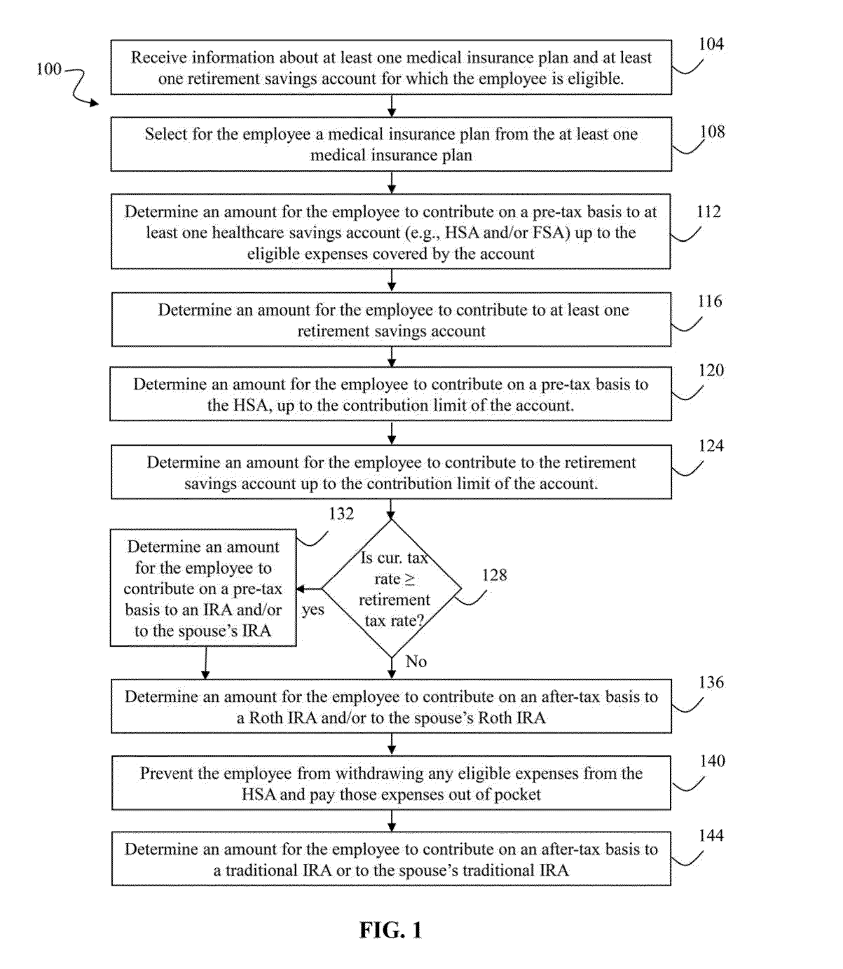

FIG. 1 shows a flow chart depicting a general process 100 for managing retirement and healthcare benefits for an employee to maximize the employee's wealth at retirement. The process 100 starts at step 104 by receiving information about various medical insurance plans and retirement plans that are available on the market. The process 100 can also receive information about various healthcare savings accounts, such as HSAs and FSAs. The employee is eligible for at least one of the medical insurance plans and the retirement plans. In some embodiments, the information about the medical insurance plans, retirement plans and healthcare savings accounts is stored in one or more databases and updated regularly with latest rules and regulations for the plans.

At step 108, the process 100 selects at least one medical insurance plan and/or at least one retirement plan for the employee to participate in. In some embodiments, instead of choosing a traditional package including a 401(k) plan (representative of a retirement plan) and a Health Maintenance Organization (HMO) or Preferred Provider Organization (PPO) (representative of a medical insurance plan), the process 100 chooses for the employee a benefits package including a 401(k) plan (representative of a retirement plan), an Individual Retirement Account (IRA) (representative of another retirement plan) and a HDHP (representative of a medical insurance plan). The process 100 can also choose one or more healthcare savings accounts for the employee, if available, such as a HSA and/or a FSA. In some embodiments, the FSA is a limited FSA. Generally, the selection of the medical and retirement plans and the allocation of funds to these plans optimize the employee's healthcare and retirement benefits by maximizing a combined future value of assets for the employee at a projected retirement age.

At step 112, the process 100 proceeds to compute an amount for the employee to contribute on a pre-tax basis to the one or more healthcare savings accounts. The contribution amount to each of the healthcare savings account can be up to (e.g., at least equal to) an estimated total of eligible expenses for the account that are not covered by the medical insurance plan. However, the contribution amount to each healthcare savings account cannot exceed a fixed cap on eligible expenses associated with the account. In some embodiments, step 112 involves instructing the employee to contribute on a pre-tax basis to a FSA up to a total of FSA-eligible expenses before instructing the employee to contribute on a pre-tax basis to a HSA up to a total of HSA-eligible expenses. In some embodiments, the process 100 instructs the employee to contribute to the HSA prior to the FSA. In general, a FSA and a HSA have the same financial value per dollar contributed, but the HSA allows any unused balance to be carried over to the subsequent plan years whereas unused balance in the FSA is forfeited if not used in the same year. In some embodiments, an investor with low healthcare expenses is instructed by the process 100 to consolidate contributions to the HSA.

At step 116, the process 100 determines an amount for the employee to contribute to at least one retirement savings account, such as to a qualified retirement plan. In some embodiments, if the employee's current marginal tax rate is the same as or higher than his expected marginal tax rate in retirement, the employee is instructed to contribute on a pre-tax basis to a 401(k) plan, up to the matching contribution limit of the plan. In some embodiments, if the employee's current marginal tax rate is the same as or lower than the employee's expected marginal tax rate in retirement, the employee is instructed to contribute on an after-tax basis to a Roth 401(k) plan, up to the matching contribution limit of the plan. For both types of 401(k) plans, it is assumed that the employer provides dollar-for-dollar matching contributions up to a specified percentage limit.

At step 120, the process 100 determines an amount for the employee to contribute on a pre-tax basis to the HSA of step 112, up to the contribution limit of the account. In some embodiments, if the employee's current marginal tax rate is high, the HSA contribution in step 120 is made before the 401(k) contribution in step 116, even assuming that the employer makes dollar-for-dollar matching to the 401(k).

At step 124, the process 100 determines another amount for the employee to contribute to the retirement savings account of step 116, such as to a regular or Roth 401(k) account. The contribution amount can be up to the contribution limit of the retirement savings account. In some embodiments, if the employee's current marginal tax rate is the same as or higher than his expected marginal tax rate in retirement, the employee is instructed to contribute on a pre-tax basis to the 401(k) plan of step 116, up to the contribution limit of the plan. In some embodiments, if the employee's current marginal tax rate is the same or lower than the employee's expected marginal tax rate in retirement, the employee is instructed to contribute on an after-tax basis to the Roth 401(k) plan of step 116, up to the contribution limit of the plan.

At step 128, the process 100 determines whether the employee's current marginal tax rate is greater than or equal to the expected marginal tax rate of the employee in retirement. If this is true, then the process 100 proceeds to step 132 to determine an amount for the employee to contribute on a pre-tax basis to an IRA and/or to the spouse's IRA. The amount can be up to the contribution limit of the IRAs. Each of the IRAs can be a traditional IRA or a Roth IRA. However, this step is not executed if the employee's current marginal tax rate is less than the expected marginal tax rate in retirement.

At step 136, the process 100 determines an amount for the employee to contribute on an after-tax basis to a Roth IRA and/or the spouse's Roth IRA. The contribution amount can be up to the contribution limit of the IRAs. In some embodiments, for individuals with expected tax rate in retirement same or higher than the current tax rate, the order of execution of steps 124, 136 and 140 does not matter as these contributions produce the same economic value in any ordering of the steps. For these individuals, one consideration that may affect the order of contribution is that for HSA withdrawals to be tax free, the expenses need to be qualified expenses, whereas withdrawals are less restrictive for Roth IRA or Roth 401(k).

At step 140, the process 100 is adapted to prevent the employee from withdrawing any eligible expenses from the HSA. Instead, the employee is instructed to pay those expenses using after-tax, out-of-pocket dollars.

Finally, at step 144, the process 100 determines an amount for the employee to contribute on an after-tax basis to a traditional IRA and/or the spouse's traditional IRA. This amount can be up to the contribution limit of the traditional IRAs.

In some embodiments, the process 100 further instructs the employee to contribute on an after-tax basis to one or more tax-deferred annuities or taxable accounts. In some embodiments, if the employee has high-interest loans such as credit card debt, the process instructs the employee to pay off the loans prior to commencing step 104.

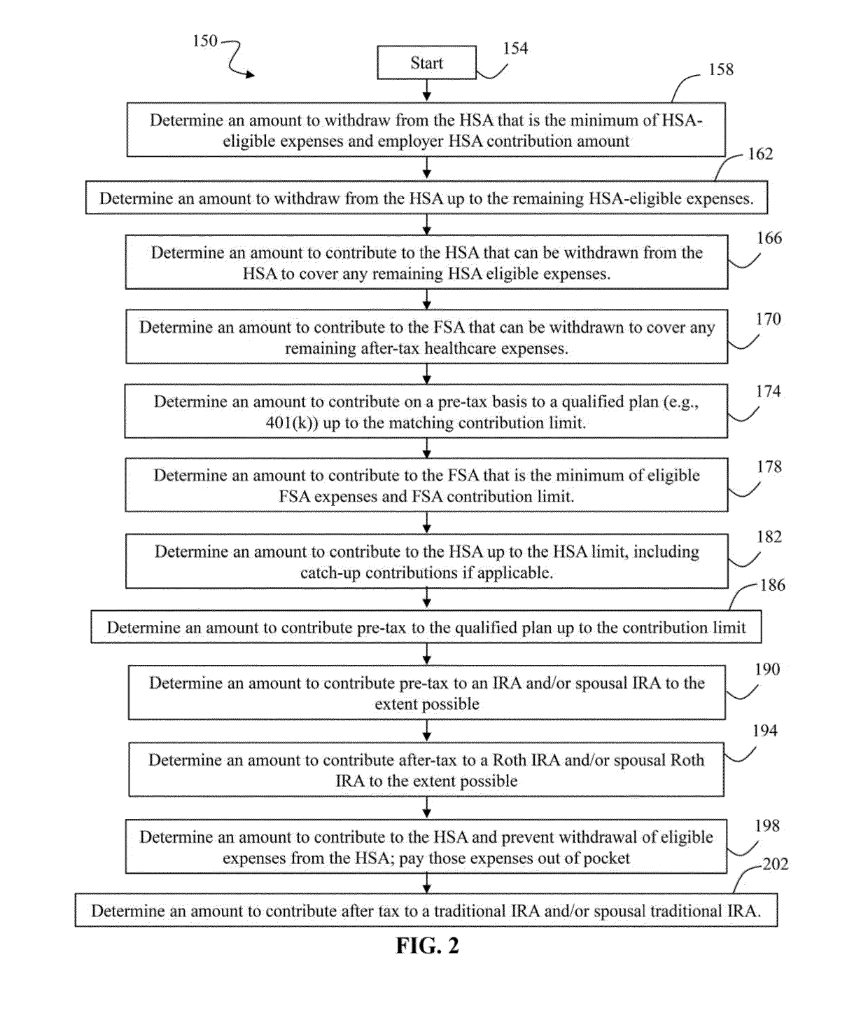

FIG. 2 shows an exemplary implementation of the general process of FIG. 1 for an employee whose current marginal tax rate is same or higher than his expected marginal tax rate in retirement. In addition, the employee is eligible to participate in: 1) one or more retirement savings accounts including a 401(k) plan and at least one IRA, 2) a medical insurance plan including a HDHP, and 3) one or more medical savings accounts including a HSA and a limited FSA.

The process 150 starts at step 154 with the assumption that zero employee contributions have been made to a qualified plan (e.g., a 401(k) plan), IRA, annuity, FSA or HSA. In some embodiments, the only contributions that have been made at step 154 include profit sharing contributions and HSA contributions by an employer. Another assumption of the process 150 is that dollars are allocated incrementally up to a given budget an employee has available to contribute for each step of the process 150. In some embodiments, the process 150 returns an error message if the employee allocates a budget less than the minimum funding level required by a step.

At step 158, the process 150 determines an amount for the employee to withdraw in the upcoming year from the HSA. In some embodiments, this amount (Annual_Withdrawal) is the smaller of the employee's estimated eligible expenses under the HSA (HSA_Eligible_Expenses) and an amount of employer contribution to the HSA (HSA_Company). Generally, the HSA eligible expenses include healthcare expenses not covered by a healthplan and qualified medical expenses, as determined by the Internal Revenue Service. The HSA withdrawal amount can be determined by the following equation:

HSA_Annual_Withdrawal=MIN(HSA_Eligible_Expenses,HSA_Company). (Eq. 1)

After the employee withdraws this amount, any remaining HSA eligible expenses can be determined by the following equation:

Remaining_HSA_Eligible_Expense=HSA_Eligible_Expenses−HSA_Annual_Withdrawal. (Eq. 2)

The remaining HSA eligible expenses, if any, represent the estimated HSA expenses in excess of the employer HSA contribution. In some embodiments, the remaining HSA eligible expenses constitute after-tax healthcare expenses to be paid by the employee with after-tax, out-of-pocket dollars.

At step 162, the process 150 estimates an additional amount the employee can withdraw at the beginning of the upcoming year from the HSA, which can be up to the remaining HSA-eligible expenses, if any, computed from Eq. 2. This amount can be used to partially or fully cover the remaining HSA eligible expenses from Eq. 2. In some embodiments, the additional amount is only available for withdrawal by the employee in the upcoming tax year if there is an existing HSA balance (HSA_Existing_Balance), which includes prior contribution carried over from one or more previous tax years that were not spent by the employee in the previous years. At this point, the running total of HSA withdrawal by the employee (HSA_Annual_Withdrawal), including the withdrawal amount made in step 158, can be determined by the following equation:

HSA_Annual_Withdrawal=MIN(HSA_Eligible_Expenses,HSA_Company+HSA_Existing_Balance). (Eq. 3)

In addition, any remaining HSA eligible expenses are determined according to the following equation:

Remaining_HSA_Eligible_expense=HSA_Eligible_Expenses−HSA_Annual_Withdrawal. (Eq. 4)

In some embodiments, the remaining HSA eligible expenses constitute after-tax healthcare expenses to be paid by the employee with after-tax, out-of-pocket dollars.

At step 166, the process 150 determines an amount for the employee to contribute to the HSA (HSA_Employee), which the employee can later withdraw from the HSA to cover the remaining HSA eligible expenses, if any, determined from Eq. 4. In some embodiments, the employee contribution amount (HSA_Employee) is up to the contribution limit of the HSA:

HSA_Employee=MIN(AT_After_FSA_HSA,IF(bMarried,HSA_Limit_Married−HSA_Company,HSA_Limit_Single−HSA_Company)). (Eq. 5)

In Eq. 5, the variable AT_After_FSA_HSA represents the after-tax amount the employee spent on healthcare after taking into account of deposits into and withdrawals from the employee's FSA and/or the HSA. According to Eq. 5, if the employee is married, as indicated by the Boolean b_Married, the employee's HSA contribution limit is different from his contribution limit if he were single. At this point, the running total of HSA withdrawal amount (HSA_Annual_Withdrawal), including the withdrawal amount made in steps 158 and 162, can be determined by the following equation:

HSA_Annual_Withdrawal=MIN(HSA_Eligible_Expenses,HSA_Company+HSA_Existing_Balance+HSA_Employee). (Eq. 6)

In some embodiments, the process 150 can additionally instruct the employee to make a catch-up contribution to the HSA if the employee is eligible and if there are remaining after-tax healthcare expenses. Total employee withdrawal up to the catch-up contribution amount to cover the remaining eligible expenses can be computed in a manner similar to Eq. 6. In some embodiments, any remaining HSA eligible expenses after the withdrawal constitute after-tax healthcare expenses to be paid by the employee with after-tax, out-of-pocket money.

At step 170, the process 150 estimates an amount for the employee to contribute to the FSA (FSA_employee), which can be up to the smaller of any remaining after-tax healthcare expenses (AT_After_FSA_HSA) and eligible FSA expenses. This amount, as computed according to Eq. 7, can be withdrawn by the employee throughout the tax year as needed. In some embodiments, the FSA contribution amount (FSA_employee) is zero if, for example, there are no remaining after-tax healthcare expenses.

FSA_Employee=MIN(MAX(AT_After_FSA_HSA,0),FSA_Eligible_Expenses). (Eq. 7)

At step 174, the process 150 estimates an amount for the employee to contribute to a qualified plan, such as to a 401(k) plan, on a pre-tax basis. This amount can be up to the matching contribution limit subjected to two options. Option 1 involves setting a Boolean flag bEmployerContributionsVested, which is set to true if employer contributions are already vested or are expected to vest before the employee separates from service (e.g., leaves the employer). Otherwise, this Boolean flag is set to false. In some embodiments, the default setting for this flag is true. If the bEmployerContributionsVested flag is set to true, the process 150 is adapted to instruct the employee to contribute up to the matching contribution limit of the qualified plan. If the flag is set to false, the process 150 is adapted to instruct the employee to contribute to the qualified plan up to the plan's Sec. 402(g) limit only after the employee has contributed to the maximum allowable limit of the HSA. This may mean that step 174 is not executed.

Option 2 involves setting a Boolean flag bMatchTo415LimitOnly, which is set to true by the process 150 if employee contributions to the qualified plan is made to the extent that the contributions are expected to be matched, such as up to the Sec. 415 limit of a 401(k) plan. As an example, for an employee whose annual income is $300,000, at most $245,000 of that income is used as compensation for contribution purposes to a qualified plan. If the employer's expected profit sharing rate in this case is 12%, this translates to a profit sharing amount of $29,400 ($245,000*0.12=$29,400). This also means that only $19,600 remains for both employee contributions and employer matching contributions ($49,000−$29,400=$19,600), where the $49,000 amount represents the maximum allowable contributions to a qualified plan (e.g., the Sec. 415 limit) for the year 2011, including both employee and employer contributions. Assuming a dollar-for-dollar match up to 10%, the employee contributes $9,800 ($19,600−$9800=$9800), which is far less than the Sec. 402(g) limit of $16,500 for 2011. Since whole percentage contributions are generally required, employee contribution is rounded up to the nearest whole percentage that satisfies the maximum allowed contribution. In this example, the employee contribution is 4%. Therefore, if the flag bMatchTo415LimitOnly is set, then $9,800 of the employee's income is allocated to the 401(k) rather than the possible limit of $16,500 for 2011. In some embodiments, the process 150 can suggest to the employee to put this difference (i.e., $16,500−$9,800=$6,700) in one or more of the other accounts, such as in the HSA.

There can be a risk associated with the second option when the bMatchTo415LimitOnly is set. For example, if the option is applied and expected profit sharing contributions do not materialize, the employee can end up foregoing additional employee contributions and employer matching contributions. Using the example above, suppose profit sharing contributions is 6% instead of 12%, then after $14,700 in profit sharing contributions ($245,000*0.06=$14,700) is made, a total of $34,300 for employee contributions and employer matching contributions remains for the year 2011 ($50,000-$14,700=$34,300). Thus, in hindsight the employee could have made the full $16,500 contribution up to the 402(g) limit, instead of only $9800.

In contrast, when the bMatchTo415LimitOnly flag is set to false, the employee can contribute up to the Sec. 402(g) limit. Using the same example above, if profit sharing contributions are indeed 12%, then $6,700 plus earning is refunded to the employee in the following year and the $6,700 in employer matching contributions (plus earnings) is forfeited in the current year. While there is no penalty to having this money refunded to the employee in the following year, the risk is one of lost opportunity. The $6,700 could have been contributed in 2011 to other accounts, such as to the HSA. Hence, for some individuals, making the full $16,500 contribution to the 401(k) plan in 2011 means forgoing the ability to take full advantage of the HSA in the same tax year.

At step 178, the process 150 estimates another amount for the employee to contribute to the FSA (FSA_Employee), which can be the minimum of any eligible FSA expense (FSA_Eligible_Expenses) and the FSA contribution limit (FSA_Contribution_Limit). In some embodiments, the employee can make withdrawals throughout the year from the FSA up to the FSA contribution amount (FSA_Employee) as needed. The FSA amount can be determined using the following equation:

FSA_Employee=MIN(FSA_Eligible_Expenses,FSA_Contribution_Limit). (Eq. 8)

In some embodiments, by contributing to the FSA, the process 150 needs to reduce the HSA eligible expenses because the HSA expenses are being assumed by the FSA. Hence, the total HSA withdrawal amount (HSA_Annual_Withdrawal) from Eq. 6 is adjusted according to the equation below:

HSA_Annual_Withdrawal=MIN(HSA_Eligible_Expenses,HSA_Company+HSA_Existing_Balance+HSA_employee) (Eq. 9)

In some embodiments, the process 150 also instructs the employee to make catch-up contributions to the HSA if the employee is eligible and if there are still remaining after-tax healthcare expenses (AT_After_FSA_HSA) that can be covered by the catch-up contributions.

At step 182, the process 150 determines an amount for the employee to contribute to the HSA up to the HSA limit, including any catch-up contributions if available. In some embodiments, no employee HSA contribution is made at step 182 because the HSA limit has already been reached due to actions taken in the prior steps. The amount of employee contribution to the HSA, if possible, can be computed according to the following equation:

HSA_Employee=IF(bMarried,HSA_Limit_Married−HSA_Company,HSA_Limit_Single−HSA_Company). (Eq. 10)

In addition, if catch-up contributions to the HSA are available, these contributions can be computed using the following equation:

HSA_Catchup=IF(currentAge>catch_up_Age_HSA,catch_up_Limit_HSA) (Eq. 11)

In some embodiments, catch-up contributions are only available to the employee if the employee satisfied an age threshold (currentAge).

At step 186, the process 150 determines an amount for the employee to contribute on a pre-tax basis to the qualified plan of step 174, such as to the 401(k) plan, up to the contribution limit of the plan. In some embodiments, if the employee is 50 years or older, the employee is allowed to contribute to the catch-up limit of the 401(k) plan as well.

At step 190, the process 150 determines an amount for the employee to contribute on a pre-tax basis to his IRA and/or the spouse's IRA, up to the contribution limit of the IRAs. Each of the IRAs can be a traditional IRA or a Roth IRA.

At step 194, the process 150 determines an amount for the employee to contribute on an after-tax basis to his Roth IRA and/or the spouse's Roth IRA, up to the contribution limit of the IRAs.

At step 198, the process 150 determines an amount for the employee to contribute to the HSA, but prevents the employee from making any withdrawal of HSA eligible expenses from the HSA. Instead, the employee is instructed to pay these expenses with after-tax, out-of-pocket dollars. Because a HSA allows tax-free withdrawal for qualified medical purposes, contributions to the HSA at step 198 provides a similar meanings for employee future retirement savings as contributing on an after-tax basis to a Roth IRA in step 194. However, contributing on an after-tax basis to a Roth IRA may be preferred because withdrawals from a Roth IRA are tax free for any purposes, assuming that the employee meets the 5-year aging requirement and the minimum age requirement for withdrawal. In contrast, withdrawals from a HSA are only tax free for qualified medical expenses. Therefore, in some embodiments, step 198 is not executed if the employee wants to consolidate his investment into the Roth IRA.

At step 202, the process 150 determines an amount for the employee to contribute on an after-tax basis to a traditional IRA and/or the spouse's traditional IRA, up to the contribution limit of the traditional IRAs. The process 150 can also recommend the employee to contribute on an after-tax basis to one or more tax-deferred annuities or efficient taxable accounts. In some embodiments, the process 150 directs the employee to invest in a tax-deferred annuity if the tax advantage of the tax deferral minus annuity account fees outweighs the tax advantage of lower capital gain rates by investing in a taxable account.

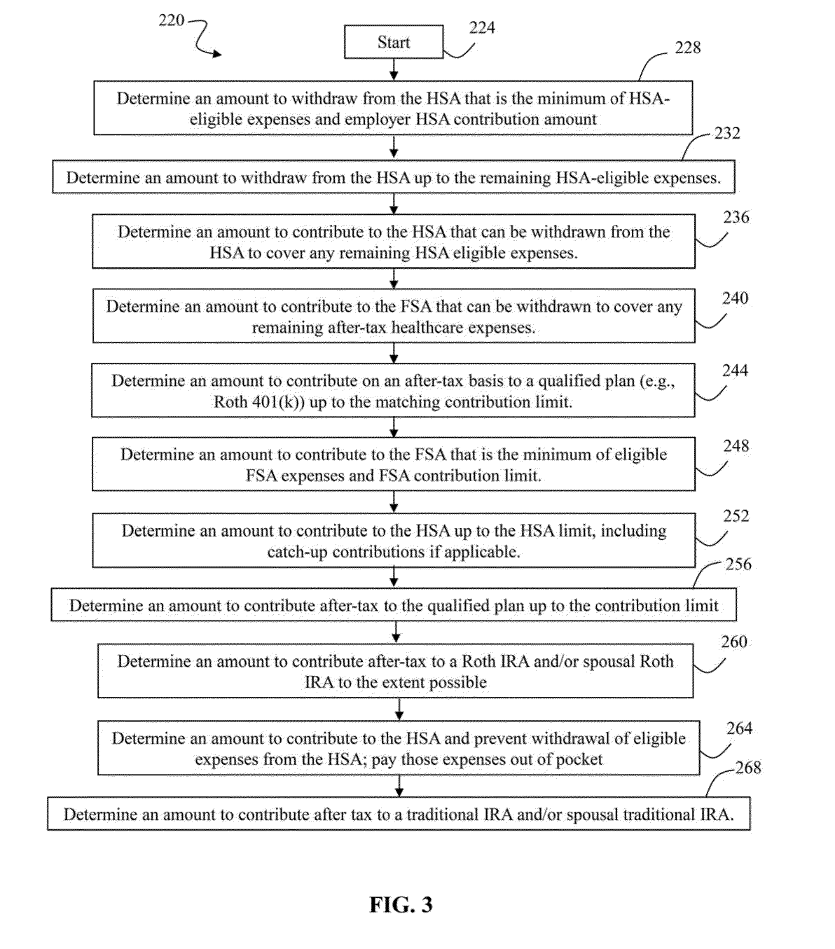

FIG. 3 shows an exemplary implementation of the general process of FIG. 1 for an employee whose current marginal tax rate is the same or less than his expected marginal tax rate in retirement. In some embodiments, if the employee's current marginal tax rate is about the same as his expected marginal tax rate in retirement, the approaches of FIG. 2 and FIG. 3 produce the same results. In addition, the employee is eligible to participate in: 1) one or more retirement savings accounts including a 401(k) plan and at least one IRA, 2) a medical insurance plan including a HDHP, and 3) one or more medical savings accounts including a HSA and a limited FSA.

The process 220 starts at step 224 with the assumption that zero employee contributions have been made to a qualified plan (e.g., a 401(k) plan), IRA, annuity, FSA or HSA. In some embodiments, the only contributions that have been made at step 224 include profit sharing contributions and HSA contributions by an employer. Another assumption of the process 220 is that dollars are allocated incrementally up to a given budget for each step of the process 220. In some embodiments, the process 150 returns an error message if the employee allocates a budget less than the minimum funding level required by a step.

At step 228, the process 220 determines an amount for the employee to withdraw in the upcoming year from the HSA. In some embodiments, this amount (Annual_Withdrawal) is the smaller of the employee's estimated eligible expenses under the HSA (HSA_Eligible_Expenses) and an amount of employer contribution to the HSA (HSA_Company). The HSA withdrawal amount can be determined by the following equation:

HSA_Annual_Withdrawal=MIN(HSA_Eligible_Expenses,HSA_Company). (Eq. 12)

After the employee withdraws this amount, any remaining HSA eligible expenses can be determined by the following equation:

Remaining_HSA_Eligible_Expense=HSA_Eligible_Expenses−HSA_Annual_Withdrawal. (Eq. 13)

The remaining HSA eligible expenses, if any, represent the estimated HSA expenses in excess of the employer HSA contribution. In some embodiments, the remaining HSA eligible expenses constitute after-tax healthcare expenses to be paid by the employee with after-tax, out-of-pocket dollars.

At step 232, the process 220 estimates an additional amount the employee can withdraw at the beginning of the upcoming year from the HSA, which can be up to the remaining HSA-eligible expenses, if any, computed from Eq. 13. This amount can be used to partially or fully cover the remaining HSA eligible expenses from Eq. 13. In some embodiments, the additional amount is only available for withdrawal by the employee in the upcoming tax year if there is an existing HSA balance (HSA_Existing_Balance) carried over from one or more previous tax years that were not spent by the employee in the previous years. At this point, the running total of HSA withdrawal amount (HSA_Annual_Withdrawal), including the withdrawal amount made in step 228, can be determined by the following equation:

HSA_Annual_Withdrawal=MIN(HSA_Eligible_Expenses,HSA_Company+HSA_Existing_Balance). (Eq. 14)

In addition, any remaining HSA eligible expenses are determined according to the following equation:

Remaining_HSA_Eligible_expense=HSA_Eligible_Expenses−HSA_Annual_Withdrawal. (Eq. 15)

In some embodiments, the remaining HSA eligible expenses constitute after-tax healthcare expenses to be paid by the employee with after-tax, out-of-pocket dollars.

At step 236, the process 220 determines an amount for the employee to contribute to the HSA (HSA_Employee), which the employee can later withdraw from the HSA to cover the remaining HSA eligible expenses, if any, as determined from Eq. 15. In some embodiments, the employee contribution amount (HSA_Employee) is up to the contribution limit of the HSA:

HSA_Employee=MIN(AT_After_FSA_HSA,IF(bMarried,HSA_Limit_Married−HSA_Company,HSA_Limit_Single−HSA_Company)). (Eq. 16)

In Eq. 16, the variable AT_After_FSA_HSA represents the amount of after-tax healthcare expenses spent by the employee after taking into account of deposits into and withdrawals from the employee's FSA and/or the HSA. According to Eq. 16, if the employee is married, as indicated by the Boolean b_Married, the employee's HSA contribution limit is different from his contribution limit if he were single. At this point, the running total of HSA withdrawal amount (HSA_Annual_Withdrawal), including the withdrawal amount made in steps 228 and 232, can be determined by the following equation:

HSA_Annual_=MIN(HSA_Eligible_Expenses,HSA_Company+HSA_Existing_Balance+HSA_Employee). (Eq. 17)

In some embodiments, the process 220 can additionally instruct the employee to make a catch-up contribution to the HSA if the employee is eligible and if there are remaining after-tax healthcare expenses. Total employee withdrawal up to the catch-up contribution amount to cover the remaining eligible expenses can be computed in a manner similar to Eq. 17. In some embodiments, any remaining HSA eligible expenses after the withdrawal constitute after-tax healthcare expenses to be paid by the employee with after-tax, out-of-pocket money.

At step 240, the process 220 estimates an amount for the employee to contribute to the FSA (FSA_employee), which can be up to the smaller of any remaining after-tax healthcare expenses (AT_After_FSA_HSA) and eligible FSA expenses. This amount, as computed according to Eq. 18 below, can be withdrawn by the employee throughout the tax year as needed. In some embodiments, the FSA contribution amount (FSA_employee) is zero if, for example, there are no remaining after-tax healthcare expenses.

FSA_Employee=MIN(MAX(AT_After_FSA_HSA,0),FSA_Eligible_Expenses). (Eq. 18)

Steps 228-240 of the process 220 can be substantially the same as steps 158-170 of the process 150 of FIG. 2. Differences between the two processes occur at step 244, at which the process 220 estimates an amount for the employee to contribute to a qualified plan, such as to a Roth 401(k) plan, on an after-tax basis. This amount can be up to the matching contribution limit subjected to two options. Option 1 involves setting a Boolean flag bEmployerContributionsVested and Option 2 involves setting a Boolean flag bMatchTo415LimitOnly, both of which are substantially the same as the corresponding flags explained above with respect to step 174 of the process 150 at FIG. 2.

At step 248, the process 220 estimates another amount for the employee to contribute to the FSA (FSA_Employee), which can be the minimum of any eligible FSA expense (FSA_Eligible_Expenses) and the FSA contribution limit (FSA_Contribution_Limit). In some embodiments, the employee can make withdrawals throughout the year from the FSA up to the FSA contribution amount (FSA_Employee) as needed. In some embodiments, by contributing to the FSA, the process 220 needs to reduce the HSA eligible expenses because the HSA expenses are being assumed by the FSA. Hence, the total HSA withdrawal amount (HSA_Annual_Withdrawal) from Eq. 17 is adjusted according to the equation below:

HSA_Annual_Withdrawal=MIN(HSA_Eligible_Expenses,HSA_Company+HSA_Existing_Balance+HSA_employee) (Eq. 18)

In some embodiments, the process 220 also instructs the employee to make catch-up contributions to the HSA if the employee is eligible and if there are still remaining after-tax healthcare expenses (AT_After_FSA_HSA) that can be covered by the catch-up contributions.

At step 252, the process 220 determines an amount for the employee to contribute to the HSA up to the HSA limit, including any catch-up contributions if available. In some embodiments, no employee HSA contribution is made at step 252 because the HSA limit has already been reached due to actions taken in the prior steps. The amount of employee contribution to the HSA, if possible, can be computed according to the following equation:

HSA_Employee=IF(bMarried,HSA_Limit_Married−HSA_Company,HSA_Limit_Single−HSA_Company). (Eq. 19)

In addition, if catch-up contributions to the HSA are available, these contributions can be computed using the following equation:

HSA_Catchup=IF(currentAge>catch_up_Age_HSA,catch_up_Limit_HSA) (Eq. 20)

In some embodiments, catch-up contributions are only available to the employee if the employee satisfied an age threshold (currentAge).

At step 256, the process 220 determines an amount for the employee to contribute on an after-tax basis to the qualified plan of step 244, such as to the Roth 401(k) plan, up to the contribution limit of the plan. In some embodiments, if the employee is 50 years or older, the employee is allowed to contribute to the catch-up limit of the Roth 401(k) plan as well.

At step 260, the process 220 determines an amount for the employee to contribute on an after-tax basis to his Roth IRA and/or the spouse's Roth IRA, up to the contribution limit of the IRAs.

At step 264, the process 220 determines an amount for the employee to contribute to the HSA, but prevents the employee from making any withdrawal of HSA eligible expenses from the HSA. Instead, the employee is instructed to pay these expenses with after-tax, out-of-pocket dollars. However, contributing on an after-tax basis to a Roth IRA at step 260 may be preferred because withdrawals from a Roth IRA are tax free for any purposes, assuming that the employee meets the 5-year aging requirement and the minimum age requirement for withdrawal. In contrast, withdrawals from a HSA are only tax free for qualified medical expenses. Therefore, in some embodiments, step 264 is not executed if the employee wants to consolidate his investment into the Roth IRA at step 260.

At step 268, the process 220 determines an amount for the employee to contribute on an after-tax basis to a traditional IRA and/or the spouse's traditional IRA, up to the contribution limit of the traditional IRAs. The process 220 can also recommend the employee to contribute on an after-tax basis to one or more tax-deferred annuities or efficient taxable accounts. In some embodiments, the process 220 directs the employee to invest in a tax-deferred annuity if the tax advantage of the tax deferral minus annuity account fees outweighs the tax advantage of lower capital gain rates by investing in a taxable account.

### Case Studies

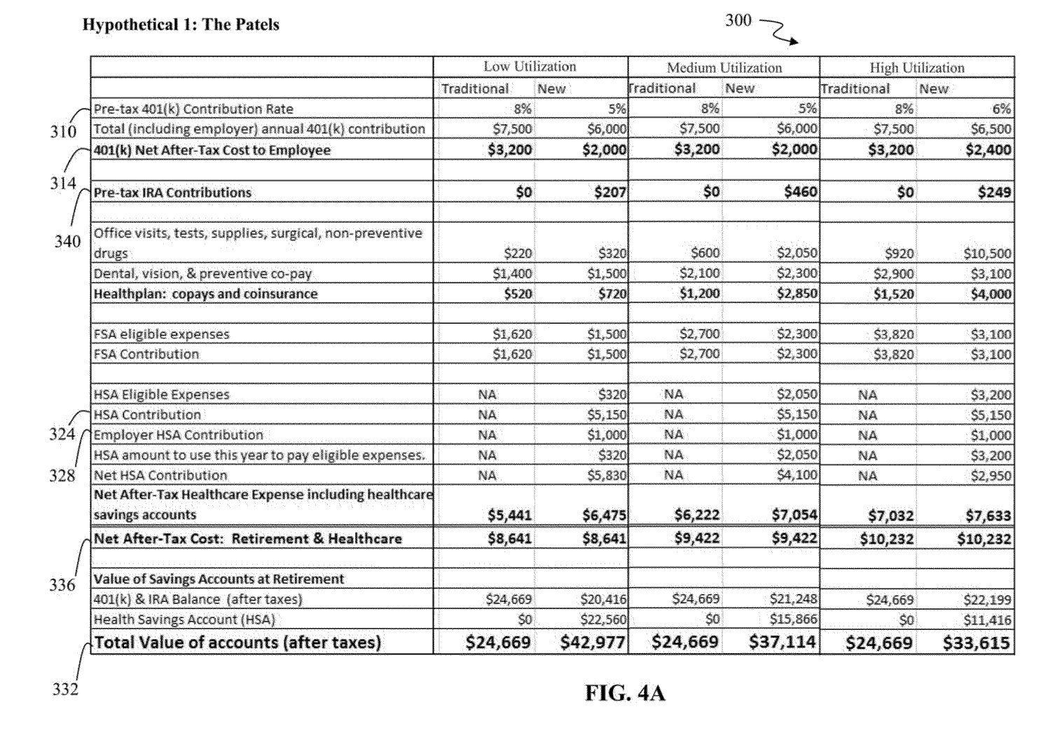

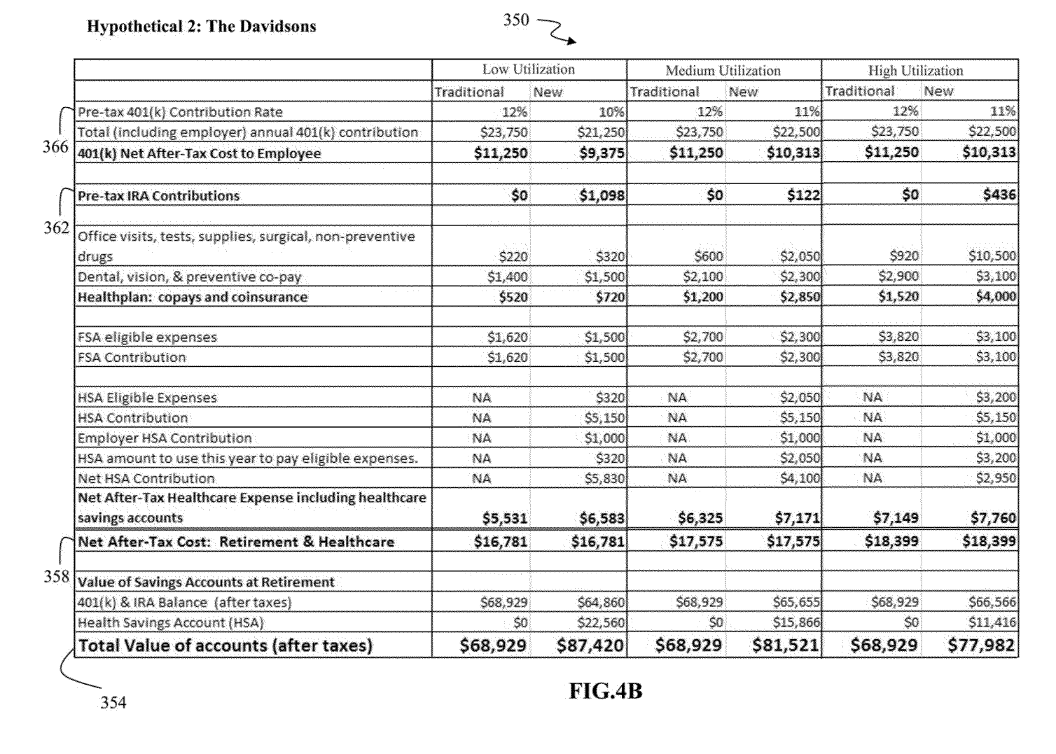

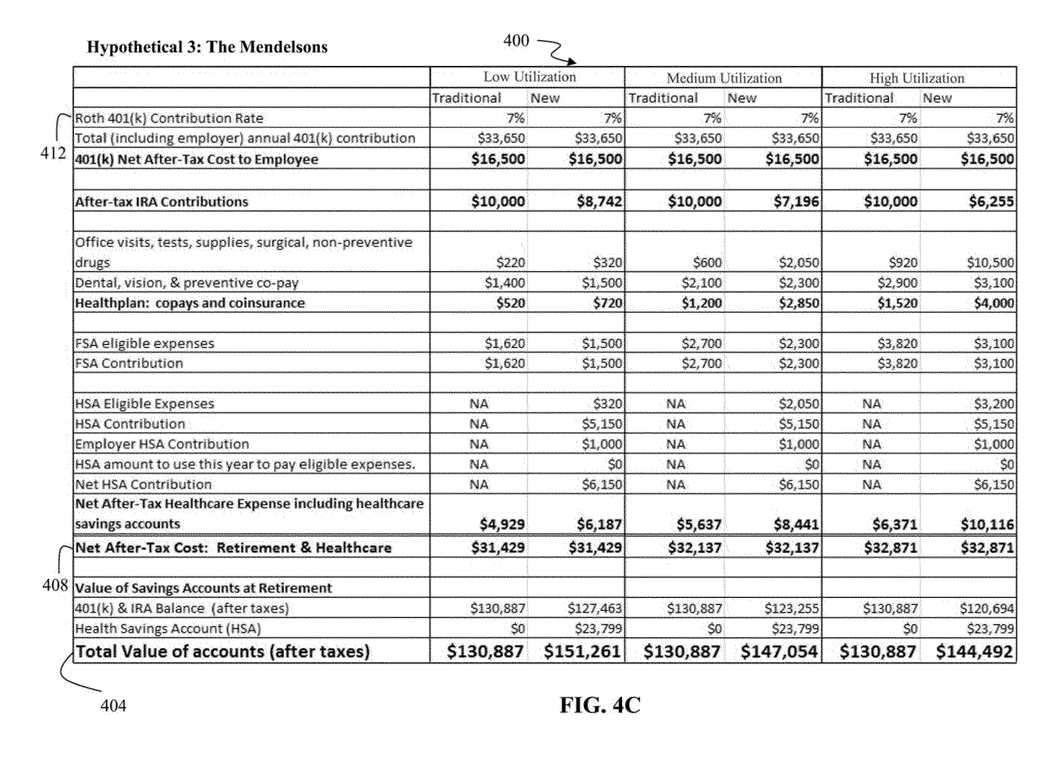

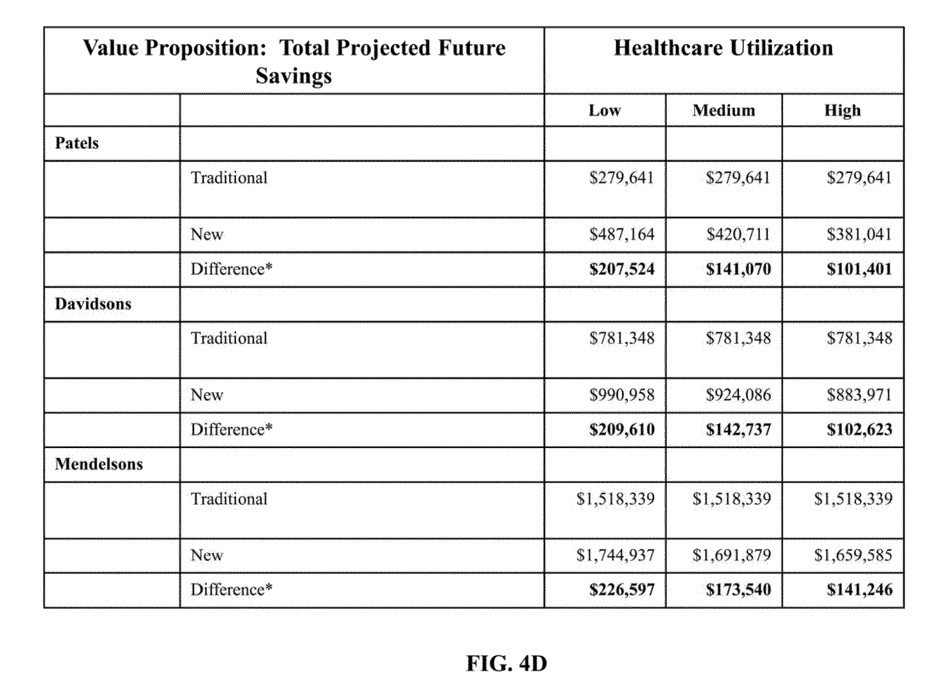

FIGS. 4A-C illustrate three case studies for utilizing the benefits allocation processes of FIGS. 1-3. The three case studies represent three hypothetical families of different income levels with one person from each family working for the same company. Specifically, the Patel family of FIG. 4A earns an annual income of $50,000, the Davidson family of FIG. 4B earns an annual income of $125,000, and the Mendelson family of FIG. 4C earns an annual income of $250,000. The assumptions made for all three hypothetical families are: employee and spouse are both 45, the retirement age is 65 (i.e., an investment period of 20 years), each household is a single-earner household, there are no other incomes except for salary paid by the company, the company's healthcare plans cover the entire family, and there is a 7% annual investment return. Other assumptions include: 6.2% social security tax and 1.45% medicare tax are applied to income and the families use only in-network providers for covered services.

Each case study shows a comparison of savings at retirement using a traditional benefits allocation approach (“traditional path”) and using the allocation approach of the present invention (“new path”). Furthermore, each case study shows benefits allocation for both traditional and new paths under low, medium and high healthcare-utilization scenarios.

For the case studies, the traditional path includes a HMO or PPO plan with an annual premium of $5,900, no annual deductible, $20 co-pay for office visits, no HSA, and access to a full-purpose FSA. In contrast, the new path includes a HDHP and an associated HSA. The new path can be associated with an annual premium of $2,300, an annual deductible of $3000 for in-network services, co-insurance above deductible of 10%, out-of-pocket maximum of $4,000 for in-network services, HSA employer contribution of $1,000, and access to a HSA-compatible, limited purpose FSA (e.g., provide reimbursement for only dental and vision related expenses). In addition, the company offers a retirement package including a 401(k) plan with dollar-for-dollar matching up to 3% and employer profit-sharing contribution of 4%. In some embodiments, data for the case studies are computed using 2011 rules and regulations, including, for example, the 2011 Internal Revenue Service limits for contributions and tax bracket determinations.

In all three healthcare utilization scenarios for the Patel family of FIG. 4A, the pre-tax 401(k) contribution rate (row 310) in the traditional path is held constant at 8%, which translates to a net after-tax cost (row 314) of $3,200. In contrast, the pre-tax 401(k) contribution rate for the Patels (row 310) is reduced to 5% in the new path, which translates to a net after-tax cost (row 314) of only $2,000. The reduction occurs because in the new path those medical expenses that are not covered by the medical insurance plan can be covered by the HSA. For the Davidsons of FIG. 4B, the differences in the pre-tax 401(k) contribution rate (row 366) between the traditional path and the new path is 2%, 1% and 1% for low, middle and high utilization levels, respectively. For the Mendelsons of FIG. 4C, due to their high household income, they contribute to the Roth 401(k) plan (row 412) to the maximum allowable limit of the plan (7%) in both the traditional and new paths for all three allocation scenarios.

In both the traditional and new paths, optimal use of the FSA has been made. For example, planned eligible FSA expenses were estimated for the three families and a FSA contribution were made in each of the nine cases equal to the estimated FSA expenses. FSA contributions enable an employee to pay for healthcare costs with pre-tax dollars, thus saving money on taxes. Withdrawals from the FSA are only permitted for qualified healthcare expenses. In the traditional path, the FSA is unlimited, meaning that it may be used for any IRS-qualified expense. In the new path, the FSA is limited, which means that the FSA may only be used to compensate for preventive co-pays and vision and dental expenses not covered by the medical insurance plan and preventive prescription co-payments, which are assumptions made for the case studies. Across the low, medium, and high healthcare utilization levels, the amounts allocated to the FSA reflect the permitted uses in each path, that is, unlimited in the traditional path and limited in the new path. As shown, the traditional path enjoys a greater tax advantage (i.e., greater tax savings) for the FSA.

However, the main driver of future accumulated savings in the new path over the traditional path is the HSA. Even though 401(k) contributions may be somewhat reduced in the new path, the HSA contributions more than made up for this reduction. The total future after-tax value of accounts can be dramatically higher in the new path. For the Patels of FIG. 4A, the increases in total account values after taxes (row 332) between the traditional path and the new path are 74%, 50%, and 36% for the low, medium, and high healthcare utilization levels, respectively. For the Davidsons of FIG. 4B, the increases in total account values after taxes (row 354) are 27%, 18%, and 13% for the low, medium, and high healthcare utilization levels, respectively. For the Mendelsons of FIG. 4C, the increases in total account values after taxes (row 404) are 16%, 12%, and 10% for the low, medium, and high healthcare utilization levels, respectively. These are increases in future savings amounts for the same cost today and the same investment risk.

The percentage gains decline as income level rises ($50,000 for the Patels, $125,000 for the Davidsons, and $250,000 for the Mendelsons) because the base future savings amount is much greater ($24,669 to $68,929, and finally $130,887), and the benefit of the HSA is somewhat fixed in dollar terms. The dollar value of the HSA is greatest when no money is withdrawn to pay for current year healthcare expenses as is done with the Mendelsons. Also, in relative terms, the advantage of a HSA over an unmatched 401(k) contribution is greatest when tax rates at retirement are highest, which also occurs with the Mendelsons.

Another observation is that the percentage gains of the new path over the traditional path decline as the utilization of healthcare increases. As expenses for healthcare increase, savings amounts are reduced when the budget (i.e., dollars allocated incrementally up to a given amount an employee has available to contribute for each step of the process) is held constant. For the Patels and the Davidsons, HSA eligible expenses are withdrawn, thus reducing the net contribution to the HSA. Still, the advantage of the new path remains strong. For the Mendelsons, their savings is greater and in all cases they can contribute to the maximum limit of 401(k) contribution (with a Roth 401(k) contribution) and HSA contribution. For the Mendelsons, increased healthcare expenses reduce their after-tax (non-Roth) IRA contributions.

Moreover, in each of the nine cases, the net after-tax cost of retirement and healthcare (row 336 of table 300, row 358 of table 350 and row 408 of table 400) are equal between the traditional path and the new path.

For the Patels and the Davidsons, there is a small IRA contribution (row 340 of table 300 and row 362 of table 350) in the new path but none in the traditional path. This occurs because of the assumed requirement that 401(k) contributions be made in whole percentages. Therefore, even though an exact contribution to the 401(k) may be preferred to exhaust the estimated healthcare expenses not covered by a medical plan, allocation often involves contributing a whole percentage for the 401(k) and a small IRA amount to compensate the remaining expenses. The effect on accumulated savings is minimal or zero, often depending on whether a person's state allows for the tax-deductibility of IRA contributions.

The data shown in FIGS. 4A-C represent future savings amounts in 20 years (at retirement) for contributions made in just one plan year (2011). If the same process is followed for the next 19 years until retirement, the total savings amount is likely to be much greater (assuming the same 7% annual return) and the advantages of the new path over the traditional path are likely to be more pronounced. Table 450 of FIG. 4D shows aggregate savings for the 20-year period. All amounts are in nominal (future) dollars and represent net after-tax amounts. The advantage of the new path over the traditional path is substantial, especially when considering that costs are the same for both paths each year and that investment risk is the same.

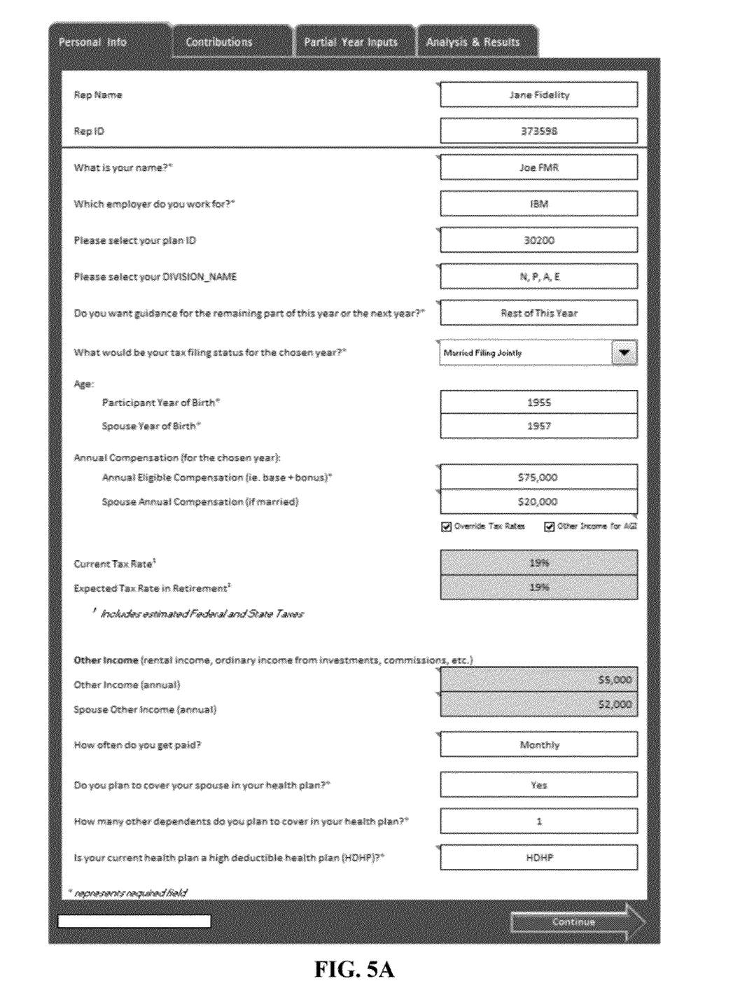

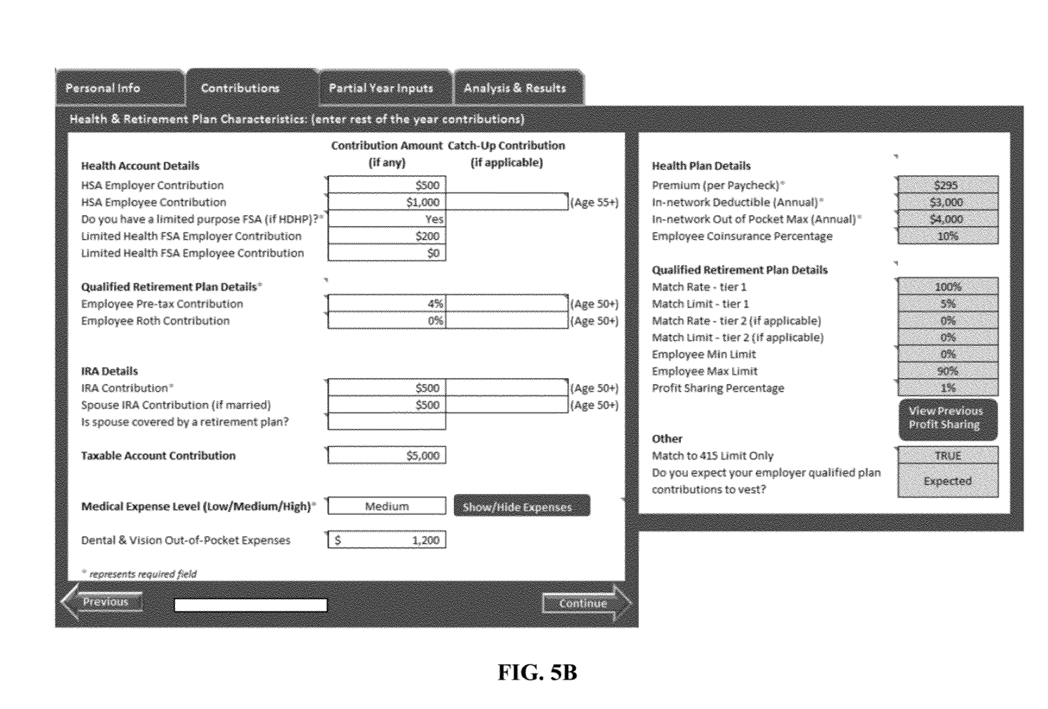

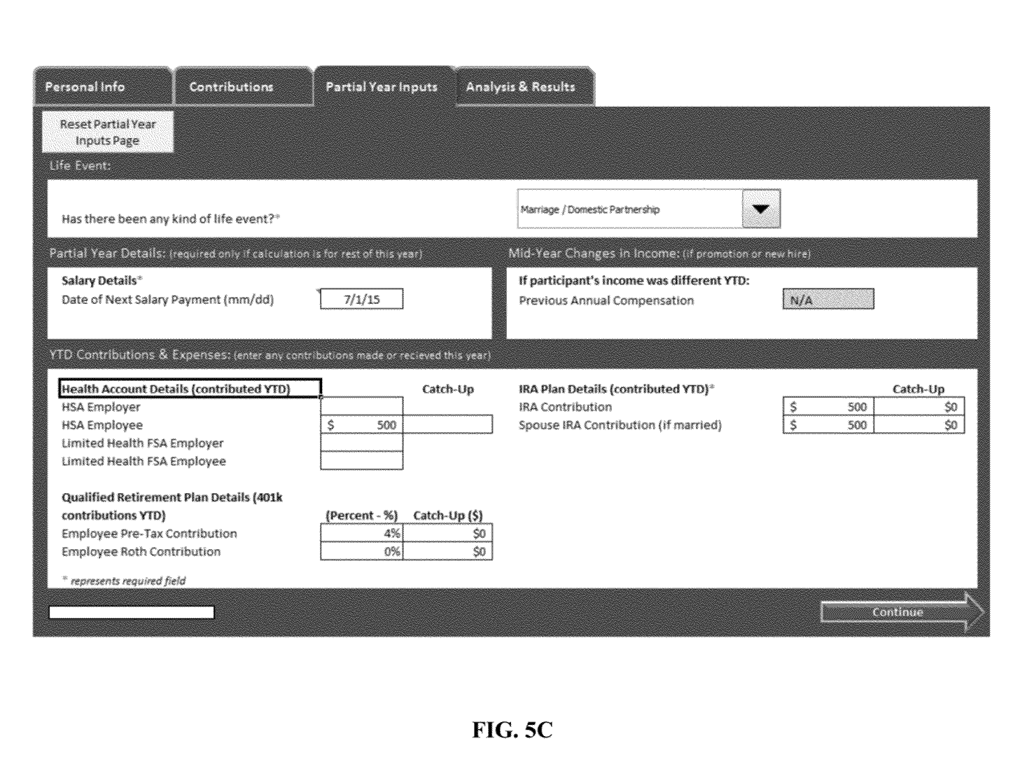

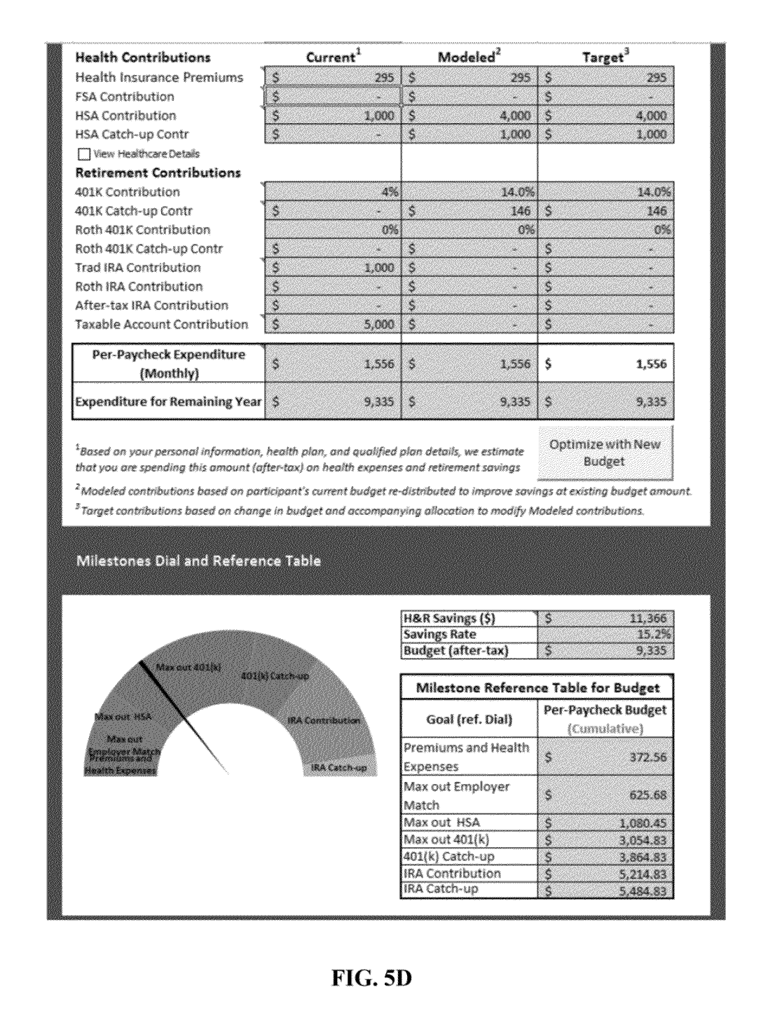

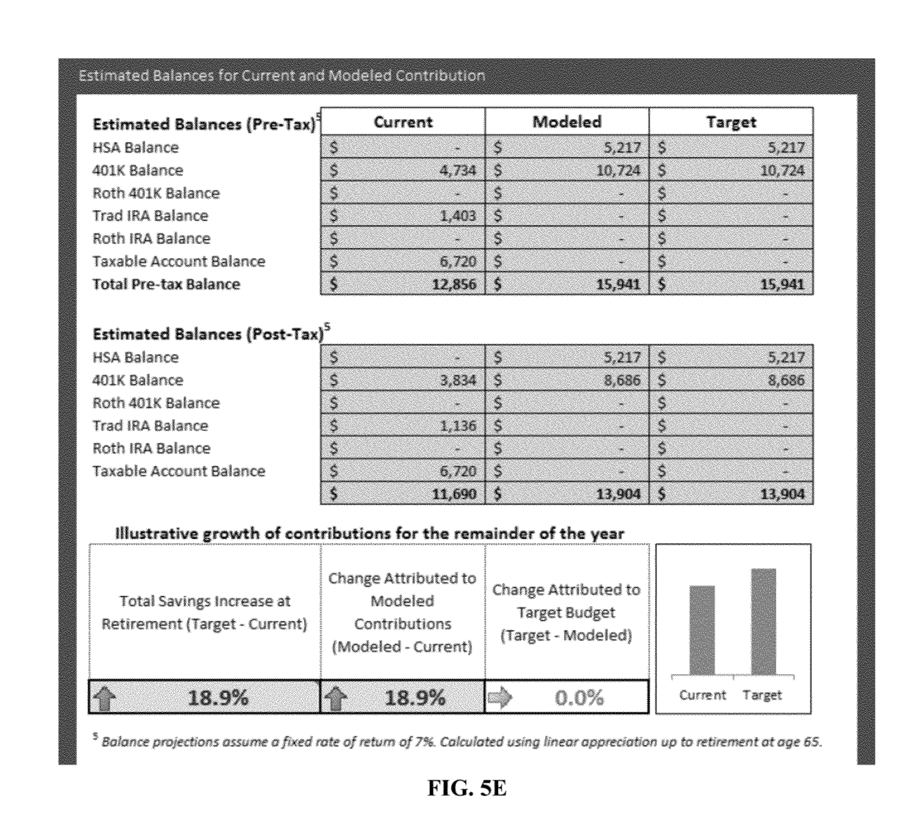

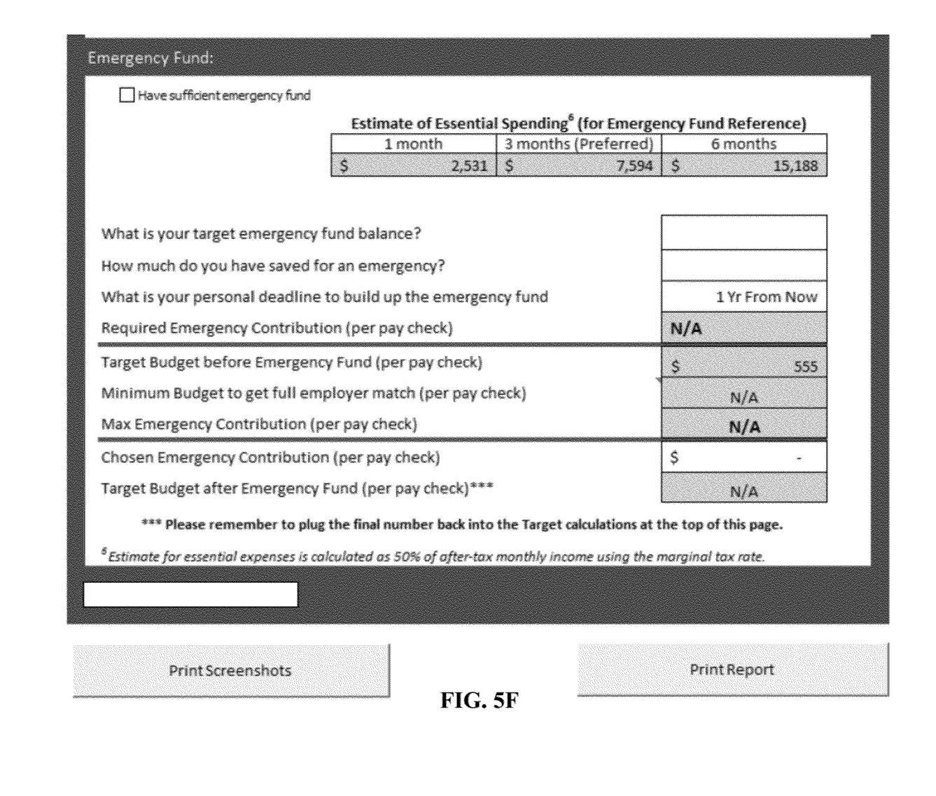

FIG. 5A is an exemplary graphical user interface (GUI) page for receiving personal information. In an embodiment, the GUI page of FIG. 5A can be used to obtain personal information about a participant. The participant (or employee) can be the user of the GUI, or the user can be someone logged into the system for the participant, such as a spouse or financial advisor. In the example shown in FIG. 5A, the GUI page receives input from the participant to confirm relevant personal information for optimizing the participant's savings dollars, including the participant's demographic information (e.g., name, year of birth, spouse year of birth, tax filing status), financial/salary information (e.g., annual compensation, spouse annual compensation, current tax rate, expected retirement tax rate, other income) and other related information (e.g., health plan coverage and features, employer, plan ID, division name). In another embodiment, when the participant enters his or her salary information, the GUI pre-populates the current tax rate, which the participant can then choose to override. This data is used to calculate tax savings and percentage of pay calculations. The information collected in the GUI page of FIG. 5A may also be retrieved from a participant database, employer database, or other relevant database—rather than obtained directly from the user or participant.

FIG. 5B is an exemplary graphical user interface (GUI) page for receiving health account and retirement plan contribution information. In an embodiment, the GUI page of FIG. 5B can be used to obtain health account and retirement plan contribution information relating to a participant. The participant (or employee) can be the user of the GUI, or the user can be someone logged into the system for the participant, such as a spouse or financial advisor. In the example shown in FIG. 5B, the GUI page receives input from the participant to confirm relevant health account and retirement plan information for optimizing the participant's savings dollars, including the participant's health account details (e.g., HSA contribution information, type of HSA), qualified retirement plan details (e.g., pre-tax and Roth contributions), IRA details (e.g., contribution amount, spouse contribution amount), taxable account contribution, medical expense level, and dental & vision out-of-pocket expenses. The GUI page of FIG. 5B also includes a health plan details section (right side of FIG. 5B) that includes information about the health plan of the participant, including premium, deductibles, maximums, coinsurance percentage, match rates, match limits, and so forth.

FIG. 5C is an exemplary graphical user interface page for receiving partial year input information. In an embodiment, the GUI page of FIG. 5C can be used to obtain partial year income details, partial year health account details (e.g., year-to-date (YTD)), partial year IRA plan details, and partial year qualified retirement plan details relating to a participant. The participant (or employee) can be the user of the GUI, or the user can be someone logged into the system for the participant, such as a spouse or financial advisor. In the example shown in FIG. 5C, the GUI page receives input from the participant to confirm relevant income, health account and retirement plan information for optimizing the participant's savings dollars, including the participant's salary details (e.g., date of next salary payment, changes in income), health account details (e.g., contributions from employer and employee), IRA plan details (e.g., contribution amount, spouse contribution amount), and qualified retirement plan details (e.g., employee pre-tax contribution and employee Roth contribution. The GUI page of FIG. 5C also includes a drop-down box for a user to indicate whether the participant has experienced any kind of life event during the year (e.g., marriage/domestic partnership, new child, divorce, death of spouse, promotion, new hire, and the like).

FIG. 5D is an exemplary graphical user interface page for representing an example savings hierarchy analysis and results including a milestones dial feature. In an embodiment, the GUI page of FIG. 5D can be used to display a customized savings analysis for a participant for the remainder of the current year. The participant (or employee) can be the user of the GUI, or the user can be someone logged into the system for the participant, such as a spouse or financial advisor. In the example shown in FIG. 5D, the GUI page displays a table of contribution information according to three categories: Current, Modeled, and Target. The Current category is an estimate of current contributions and expenses by the participant relating to health and retirement savings, based upon the information provided by the participant. The Modeled category is a model of contributions and expenses based upon the participant's current budget and re-distributed to improve savings at the existing budget amount. The Target category is a model of contributions and expenses based upon a changed participant budget and accompanying allocation to modify the Modeled contributions. The GUI page also includes an Optimize with New Budget button that enables the participant to adjust his or her budget (e.g., the per-paycheck expenditure field) for the Target category and determine how the adjusted budget would affect the corresponding savings and contribution amounts.

Further, the GUI page includes a milestones dial feature in the bottom portion of the page that displays certain health and retirement savings and contribution goals on a progressive scale so that the participant can see how much of a per-paycheck budget is required to meet each of the goals. For example, as shown in FIG. 5D, the initial savings and contribution goal is to meet existing premiums and health expenses (shown as the first sector in the milestones dial and the first row in the milestone reference table). To meet this goal, the participant needs to allocate a per-paycheck budget of $372.56. The next savings and contribution goal is to max out employer match for retirement accounts; to meet both the initial goal and the second goal, the participant has to allocate a per-paycheck budget of $625.68. The savings and contribution goals continue progressively, until the last goal of IRA catch-up. Thus, in order to meet all of the goals depicted in FIG. 5D, the participant has to allocate $5,484.83 per paycheck. The milestones dial tracks the current status of the participant's achievement of the goals. For example, as shown in FIG. 5D, the milestones dial includes a needle (the dark line extending from the middle of the dial to the ‘max out 401(k)’ area) that shows the participant where he or she is in terms of meeting relevant savings and contribution goals. In this example, the participant is currently allocating a per-paycheck budget of $1,556—which corresponds to meeting the goals of existing premiums and health expenses, max out employer match, and max out HSA, along with making progress toward maxing out 401(k).

FIG. 5E is an exemplary graphical user interface page for representing an example estimated balances analysis including an illustrative growth feature. In an embodiment, the GUI page of FIG. 5E can be used to display estimated balances for the current contribution amounts, the modeled contribution amounts, and the target contribution amounts for each of the various balances—both pre-tax and post-tax. The GUI page of FIG. 5E also includes an illustrative growth feature on the bottom portion of the page that depicts the total savings increase at retirement between the target balance and the current balance, the change attributed to the modeled contributions from the current balance, and the change attributed to the target budget. The participant (or employee) can be the user of the GUI, or the user can be someone logged into the system for the participant, such as a spouse or financial advisor.

FIG. 5F is an exemplary graphical user interface page for representing an example emergency fund analysis. In an embodiment, the GUI page of FIG. 5F can be used to obtain and display amounts relating to an emergency fund to meet essential expenses of the user. The participant (or employee) can be the user of the GUI, or the user can be someone logged into the system for the participant, such as a spouse or financial advisor. In the example shown in FIG. 5F, the GUI Page displays an estimate of essential spending at the top of the page—which shows a one-month, a three-month, and a six-month estimate determined by the system that should be held in reserve for an emergency fund.

The GUI page also includes input fields for the user to enter a target emergency fund balance, an estimate of how much the user has saved for an emergency, and a personal deadline (e.g., 1 year from now) for the user to build up funds to meet the target emergency fund amount. The system then determines a target budget amount (per pay check) before emergency fund, a minimum budget (per pay check) to get full employer match, and a maximum emergency contribution (per pay check).

The above-described techniques and processes, such as the processes of FIGS. 1-3, can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, microprocessors capable of receiving instructions and data from a read-only memory or a random access memory or both, and executing the instructions. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system (e.g., a cloud-computing system) that includes any combination of such back-end, middleware, or front-end components. The above described techniques can be implemented as a Software-As-A-Service (SaaS) model or using a multi-tiered approach.

Communication networks can include one or more packet-based networks and/or one or more circuit-based networks in any configuration. Packet-based networks can include, for example, an Ethernet-based network (e.g., traditional Ethernet as defined by the IEEE or Carrier Ethernet as defined by the Metro Ethernet Forum (MEF)), an ATM-based network, a carrier Internet Protocol (IP) network (LAN, WAN, or the like), a private IP network, an IP private branch exchange (IPBX), a wireless network (e.g., a Radio Access Network (RAN)), and/or other packet-based networks. Circuit-based networks can include, for example, the Public Switched Telephone Network (PSTN), a legacy private branch exchange (PBX), a wireless network (e.g., a RAN), and/or other circuit-based networks. Carrier Ethernet can be used to provide point-to-point connectivity (e.g., new circuits and TDM replacement), point-to-multipoint (e.g., IPTV and content delivery), and/or multipoint-to-multipoint (e.g., Enterprise VPNs and Metro LANs). Carrier Ethernet advantageously provides for a lower cost per megabit and more granular bandwidth options.

Devices of the computing system can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer, mobile device) with a world wide web browser (e.g., Microsoft® Internet Explorer® available from Microsoft Corporation, Mozilla® Firefox available from Mozilla Corporation).

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed:

1. A computerized method for optimizing healthcare and retirement benefits for an employee, the method comprising:
receiving, by a computing device from a graphical user interface device, input identifying a participant and a contribution budget for the participant that specifies a total amount available for allocation for a remaining part of the current year;
determining, by the computing device, one or more medical insurance plans for which the participant is eligible;
selecting, by the computing device, a medical insurance plan from the one or more medical insurance plans for which the employee is eligible based upon the contribution budget;
determining, by the computing device, at least one health care savings account associated with the at least one medical insurance plan;
retrieving, by the computing device, information identifying a plurality of financial accounts associated with the participant, wherein the plurality of financial accounts comprises at least a retirement account associated with a retirement plan, a qualified plan, and at least one health care account associated with a health care plan, wherein the retrieved information comprises at least an annual limit on participant contribution amounts for each of the financial accounts and previous contribution amounts deposited respectively in each of the financial accounts during the current year by the participant;
generating, by the computing device, a savings hierarchy that identifies a plurality of savings milestones for the remaining part of the current year represented by data comprising (i) a recommended funding sequence of the plurality of financial accounts, the qualified plan, and the health care account and (ii) recommended contribution amounts for the plurality of financial accounts, the qualified plan and the health care account at each step of the funding sequence for the remaining part of the current year, wherein the recommended funding sequence and the recommended contribution amounts are dependent on the partial year adjusted contribution limits, including
(a) providing, by the computing device, recommendation of a first amount for the employee to contribute on a pre-tax basis to the at least one health care savings account, wherein the first amount is equal to smaller of (i) an estimated total of eligible expenses not covered by the medical insurance plan and (ii) a contribution limit of the health care savings account, the estimated total eligible expenses representing an after-tax amount the employee spends on healthcare reduced by at least one of employer contribution to the health care savings account or existing balance in the health care savings account;
(b) providing, by the computing device, recommendation of a second amount for the employee to contribute to the qualified plan, wherein the second amount is equal to a matching contribution limit of the qualified plan;
(c) providing, by the computing device, recommendation of a third amount for the employee to contribute on a pre-tax basis to the at least one health care savings account, wherein the third amount is equal to smaller of (i) a remaining eligible expense after the first amount is subtracted from the eligible expenses and (ii) the contribution limit of the at least one health care savings account subtracted by the first amount;
(d) providing, by the computing device, recommendation of a fourth amount for the employee to contribute to the qualified plan, wherein the fourth amount is equal to the contribution limit of the qualified plan subtracted by the second amount; and
(e) providing, by the computing device, recommendation of a fifth amount for the employee to contribute to the at least one retirement account, wherein the fifth amount is equal to a contribution limit of the at least one retirement account;
allocating, by the computing device, the contribution budget across the financial accounts according to the recommended funding sequence and up to the recommended contribution amounts of the savings hierarchy limited by the contribution budget; and
transmitting, by the computing device, the saving hierarchy including the recommended funding sequence and the recommended contribution amounts for display on the graphical user interface device, wherein the display includes an arc-shaped spectrum graphical representation that visually depicts (i) the savings hierarchy as a plurality of consecutive sectors, each sector identifying a step in the recommended funding sequence, a length of each sector representing a corresponding recommended contribution amount, and the respective positions of the plurality of consecutive sectors representing the recommended funding sequence and (ii) a graphical indicator referencing a position on the savings hierarchy that represents a level to which the financial accounts are funded by the allocated contribution budget.

2. The computer-implemented method of claim 1 wherein the at least one health care savings account comprises a flexible spending account or a health savings account.

3. The computer-implemented method claim 1, further comprising:
determining, by the computing device, a first pre-tax amount for the employee to contribute to a flexible spending account having a fixed cap for eligible expenses not covered by the medical insurance plan; and
determining, by the computing device, a second pre-tax amount for the employee to contribute to a health savings account for eligible expenses not covered by the medical insurance plan, wherein proceeds of the health savings account can be carried over to a subsequent plan year.

4. The computer-implemented method of claim 1 wherein the at least one retirement savings account comprises a qualified plan and the second amount is less than or equal to a matching contribution limit of the qualified plan.

5. The computer-implemented method of claim 4 wherein the qualified plan comprises a 401(k) plan, the second amount comprises a pre-tax contribution, and an expected marginal tax rate of the employee in retirement is less than or equal to a current marginal tax rate of the employee.

6. The computer-implemented method of claim 4 wherein the qualified plan comprises a Roth 401(k) plan, the second amount comprises an after-tax contribution, and an expected marginal tax rate of the employee in retirement is greater than or equal to a current marginal tax rate of the employee.

7. The computer-implemented method of claim 1 further comprising:
determining, by the computing device, a third amount for the employee to contribute on a pre-tax basis to the at least one health care savings account, wherein the third amount is less than or equal to a contribution limit of the at least one health care savings account; and
determining, by the computing device, a fourth amount for the employee to contribute to the at least one retirement savings account, wherein the fourth amount is less than or equal to a contribution limit of the at least one retirement savings account.

8. The computer-implemented method of claim 7 wherein the fourth amount comprises a pre-tax contribution, the at least one retirement savings account comprises a 401(k) plan, and an expected marginal tax rate of the employee in retirement is less than or equal to a current marginal tax rate of the employee.

9. The computer-implemented method of claim 7, wherein the fourth amount comprises an after-tax contribution, the at least one retirement savings account comprises a Roth 401(k) plan, and an expected marginal tax rate of the employee in retirement is greater than or equal to a current marginal tax rate of the employee.

10. The computer-implemented method of claim 7, further comprising:
determining, by the computing device, an amount for the employee to contribute on a pre-tax basis to at least one of an IRA of the employee or an IRA of a spouse of the employee; and
determining, by the computing device, an amount for the employee to contribute on an after-tax basis to a Roth IRA of the employee or a Roth IRA of a spouse of the employee.

11. The computer-implemented method of claim 10 wherein determining the amount for the employee to contribute on a pre-tax basis to an IRA is not executed by the computing device when an expected marginal tax rate of the employee in retirement is greater than or equal to a current marginal tax rate of the employee.

12. The computer-implemented method of claim 10, further comprising:
preventing, by the computing device, the employee from withdrawing an eligible expense from the at least one health care savings account.

13. The computer-implemented method of claim 12, further comprising:
determining, by the computing device, an amount for the employee to contribute on an after-tax basis to at least one of a traditional IRA of the employee or a traditional IRA of a spouse of the employee.

14. The computer-implemented method of claim 13, further comprising:
determining, by the computing device, an amount for the employee to contribute on an after-tax basis to a tax-deferred annuity or a taxable account.

15. A computer program product, tangibly embodied in a computer readable medium, for optimizing healthcare and retirement benefits for an employee, the computer program product including instructions being operable to cause a computing device to:
receive, from a graphical user interface device, input identifying a participant and a contribution budget for the participant that specifies a total amount available for allocation for a remaining part of the current year;
determine one or more medical insurance plans for which the participant is eligible;
select a medical insurance plan from the one or more medical insurance plans for which the employee is eligible based upon the contribution budget;
determine at least one health care savings account associated with the at least one medical insurance plan;
retrieve information identifying a plurality of financial accounts associated with the participant, wherein the plurality of financial accounts comprises at least a retirement account associated with a retirement plan, a qualified plan, and at least one health care account associated with a health care plan, wherein the retrieved information comprises at least an annual limit on participant contribution amounts for each of the financial accounts and previous contribution amounts deposited respectively in each of the financial accounts during the current year by the participant;
generate a savings hierarchy that identifies a plurality of savings milestones for the remaining part of the current year represented by data comprising (i) a recommended funding sequence of the plurality of financial accounts, the qualified plan, and the health care account and (ii) recommended contribution amounts for the plurality of financial accounts, the qualified plan and the health care account at each step of the funding sequence for the remaining part of the current year, wherein the recommended funding sequence and the recommended contribution amounts are dependent on the partial year adjusted contribution limits, including
(a) providing, by the computing device, recommendation of a first amount for the employee to contribute on a pre-tax basis to the at least one health care savings account, wherein the first amount is equal to smaller of (i) an estimated total of eligible expenses not covered by the medical insurance plan and (ii) a contribution limit of the health care savings account, the estimated total eligible expenses representing an after-tax amount the employee spends on healthcare reduced by at least one of employer contribution to the health care savings account or existing balance in the health care savings account;
(b) providing, by the computing device, recommendation of a second amount for the employee to contribute to the qualified plan, wherein the second amount is equal to a matching contribution limit of the qualified plan;
(c) providing, by the computing device, recommendation of a third amount for the employee to contribute on a pre-tax basis to the at least one health care savings account, wherein the third amount is equal to smaller of (i) a remaining eligible expense after the first amount is subtracted from the eligible expenses and (ii) the contribution limit of the at least one health care savings account subtracted by the first amount;
(d) providing, by the computing device, recommendation of a fourth amount for the employee to contribute to the qualified plan, wherein the fourth amount is equal to the contribution limit of the qualified plan subtracted by the second amount; and
(e) providing, by the computing device, recommendation of a fifth amount for the employee to contribute to the at least one retirement account, wherein the fifth amount is equal to a contribution limit of the at least one retirement account;
allocate the contribution budget across the financial accounts according to the recommended funding sequence and up to the recommended contribution amounts of the savings hierarchy limited by the contribution budget; and
transmit the saving hierarchy including the recommended funding sequence and the recommended contribution amounts for display on the graphical user interface device, wherein the display includes an arc-shaped spectrum graphical representation that visually depicts (i) the savings hierarchy as a plurality of consecutive sectors, each sector identifying a step in the recommended funding sequence, a length of each sector representing a corresponding recommended contribution amount, and the respective positions of the plurality of consecutive sectors representing the recommended funding sequence and (ii) a graphical indicator referencing a position on the savings hierarchy that represents a level to which the financial accounts are funded by the allocated contribution budget.

16. A system for optimizing healthcare and retirement benefits for an employee, the system comprising a computing device configured to:
receive, from a graphical user interface device, input identifying a participant and a contribution budget for the participant that specifies a total amount available for allocation for a remaining part of the current year;
determine one or more medical insurance plans for which the participant is eligible;
select a medical insurance plan from the one or more medical insurance plans for which the employee is eligible based upon the contribution budget;
determine at least one health care savings account associated with the at least one medical insurance plan;
retrieve information identifying a plurality of financial accounts associated with the participant, wherein the plurality of financial accounts comprises at least a retirement account associated with a retirement plan, a qualified plan, and at least one health care account associated with a health care plan, wherein the retrieved information comprises at least an annual limit on participant contribution amounts for each of the financial accounts and previous contribution amounts deposited respectively in each of the financial accounts during the current year by the participant;
generate a savings hierarchy that identifies a plurality of savings milestones for the remaining part of the current year represented by data comprising (i) a recommended funding sequence of the plurality of financial accounts, the qualified plan, and the health care account and (ii) recommended contribution amounts for the plurality of financial accounts, the qualified plan and the health care account at each step of the funding sequence for the remaining part of the current year, wherein the recommended funding sequence and the recommended contribution amounts are dependent on the partial year adjusted contribution limits, including
(a) providing, by the computing device, recommendation of a first amount for the employee to contribute on a pre-tax basis to the at least one health care savings account, wherein the first amount is equal to smaller of (i) an estimated total of eligible expenses not covered by the medical insurance plan and (ii) a contribution limit of the health care savings account, the estimated total eligible expenses representing an after-tax amount the employee spends on healthcare reduced by at least one of employer contribution to the health care savings account or existing balance in the health care savings account;
(b) providing, by the computing device, recommendation of a second amount for the employee to contribute to the qualified plan, wherein the second amount is equal to a matching contribution limit of the qualified plan;
(c) providing, by the computing device, recommendation of a third amount for the employee to contribute on a pre-tax basis to the at least one health care savings account, wherein the third amount is equal to smaller of (i) a remaining eligible expense after the first amount is subtracted from the eligible expenses and (ii) the contribution limit of the at least one health care savings account subtracted by the first amount;
(d) providing, by the computing device, recommendation of a fourth amount for the employee to contribute to the qualified plan, wherein the fourth amount is equal to the contribution limit of the qualified plan subtracted by the second amount; and
(e) providing, by the computing device, recommendation of a fifth amount for the employee to contribute to the at least one retirement account, wherein the fifth amount is equal to a contribution limit of the at least one retirement account;
allocate the contribution budget across the financial accounts according to the recommended funding sequence and up to the recommended contribution amounts of the savings hierarchy limited by the contribution budget; and
transmit the saving hierarchy including the recommended funding sequence and the recommended contribution amounts for display on the graphical user interface device, wherein the display includes an arc-shaped spectrum graphical representation that visually depicts (i) the savings hierarchy as a plurality of consecutive sectors, each sector identifying a step in the recommended funding sequence, a length of each sector representing a corresponding recommended contribution amount, and the respective positions of the plurality of consecutive sectors representing the recommended funding sequence and (ii) a graphical indicator referencing a position on the savings hierarchy that represents a level to which the financial accounts are funded by the allocated contribution budget.
